(19) United States
(12) Patent Application Publication
(10) Pub. No.: US 2023/0199329 A1
(43) Pub. Date: Jun. 22, 2023

(54) IMAGE CAPTURING SYSTEM, MOVING DEVICE, IMAGE CAPTURING METHOD, AND STORAGE MEDIUM

(71) Applicant: CANON KABUSHIKI KAISHA, Tokyo (JP)

(72) Inventor: YUICHI SUEYOSHI, Tokyo (JP)

(21) Appl. No.: 18/063,096

(22) Filed: Dec. 8, 2022

(30) Foreign Application Priority Data
Dec. 20, 2021 (JP) 2021-205978

(51) Int. Cl. H04N 23/80; H04N 7/18

(52) U.S. Cl. CPC H04N 23/815; H04N 7/183; B60R 1/28

(57) ABSTRACT

An image capturing system having an image capturing device; a display device that displays a screen for image data that has been acquired by the image capturing device; a region setting unit configured to set a high-resolution region in one portion of the screen; an angle detection unit configured to detect an angle of inclination of the display surface of the display device; and a control unit configured to change a position of the high-resolution region that is set by the region setting unit according to the angle of inclination of the display surface that has been obtained by the angle detection unit.

### BACKGROUND OF THE INVENTION

### Field of the Invention

The present invention relates to an image capturing system, a moving device, an image capturing method, and a storage medium.

### Description of Related Art

In recent years, there has been a demand for replacing the room mirrors (rear view mirrors) that are mounted in vehicles with electronic room mirrors. For example, Japanese Unexamined Patent Application, First Publication No. 2019-166887 discloses an electronic room mirror system having an image capturing device with the rear of the outside of the vehicle as the image capturing range, and a display device inside the vehicle, wherein the driver is able to confirm the state of the rear of the outside of the vehicle by displaying the image that has been captured by the image capturing device on the display device inside of the vehicle.

In contrast, a technique for capturing video images for use in an electronic room mirror and for use in a rear confirmation monitor for reversing (a “back monitor” below) using one camera is being considered with the goal of reducing the number of cameras. The electronic room mirror requires video images that have been captured at a high-resolution from farther distances, whereas the back monitor requires video images that have been captured at a wider angler so as to show rear blind spots. Therefore, the output video images of such cameras include low-distortion, high-resolution regions for use by the electronic room mirror, and wide angle, low-resolution regions for use by the back monitor.

In the case in which the driver would like to adjust the field of view that is shown in the room mirror, adjustment is possible by changing the inclination of the room mirror itself for a conventional optical room mirror. In contrast, in the case of an electronic room mirror, even if the room mirror itself is moved, the video that is being displayed will not change, and therefore, it is difficult to intuitively adjust the field of vision in the same manner as for an optical mirror.

In addition, in the case in which, as mentioned above, a camera has both a low-distortion, high-resolution region, and a wide angle, low-resolution region, it is preferable that that electronic room mirror displays the high-resolution region. However, the high-resolution region has a narrow angle of view, and therefore, there is the problem that the rear field of view that can be displayed on the electronic room mirror will be made limited.

### SUMMARY OF THE INVENTION

An image capturing system according to one aspect of the present invention has an image capturing device; a display device that displays a screen of image data that has been acquired by the image capturing device; and at least one processor or circuit configured to function as:

a region setting unit configured to set a high-resolution region in one portion of the screen, an angle detection unit configured to detect an angle of inclination of a display surface of the display device, and a control unit configured to change a position of the high-resolution region that is set by the region setting unit according to the angle of inclination of the display surface that was obtained by the angle detection unit.

Further features of the present invention will become apparent from the following description of Embodiments with reference to the attached drawings.

### BRIEF DESCRIPTION OF THE DRAWINGS

FIG. 1 is a functional block diagram explaining an image capturing system 100 in a First Embodiment.

FIGS. 2A and 2B are schematic diagrams in which an electronic room mirror 20 in the First Embodiment is seen from the side.

FIG. 3 is a flow chart explaining the operations of the image capturing system 100 in the First Embodiment.

FIGS. 4A and 4B are diagrams for explaining an angle of view of an image capturing device 10 that has been attached to the rear portion of a vehicle 30 in the First Embodiment.

FIGS. 5A and 5B are diagrams for explaining a region of a video image of the rear direction of a vehicle that is displayed on a display device 16 in the First Embodiment.

FIGS. 6A and 6B are diagrams for explaining the optical properties of an optical system 11 in a Second Embodiment.

FIG. 7 is a functional block diagram explaining the image capturing system 100 in a Third Embodiment.

FIG. 8 is a flowchart for explaining the operations of an integration processing unit in the Third Embodiment.

FIG. 9 is a functional block diagram explaining the image capturing system 100 in a Fourth Embodiment.

### DETAILED DESCRIPTION OF THE INVENTION

Hereinafter, with reference to the accompanying drawings, favorable modes of the present invention will be described using Embodiments. In each diagram, the same reference signs are applied to the same members or elements, and redundant descriptions will be omitted or simplified.

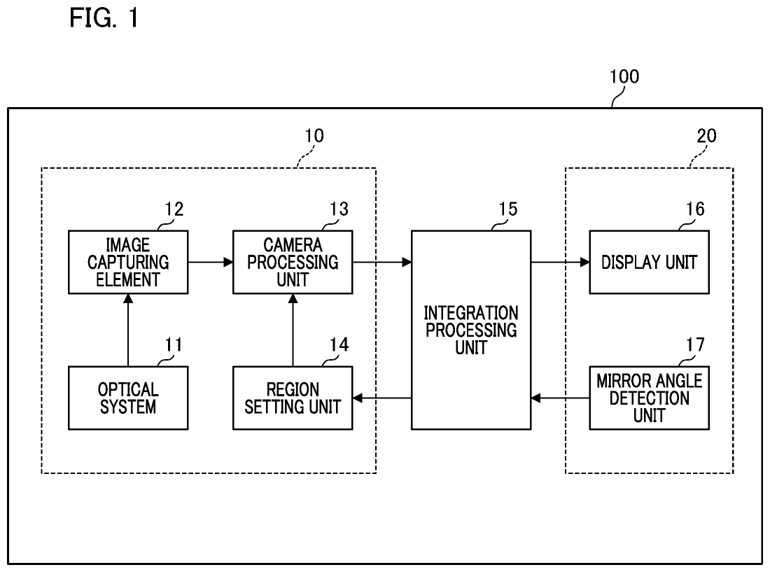

FIG. 1 is a diagram explaining an image capturing system 100 in a First Embodiment of the present invention. Note that one or more of the functional blocks shown in FIG. 1 may also be realized by hardware such as an ASIC, a programmable logic array (PLA), or the like. Alternatively, they may also be realized by a programmable processor, which is not illustrated, such as a CPU, MPU, and the like, that is included in the image capturing system 100, executing software. In addition, they may also be realized by a combination of software and hardware.

Therefore, in the following explanation, even in the case in which a different functional block is disclosed as being the subject of the operation, it can be realized with the same hardware serving as the subject. ASIC is an abbreviation of “Application Specific Integrated Circuit” (an integrated circuit for a specific use). CPU is an abbreviation of “Central Processing Unit”. MPU is an abbreviation of “Micro-Processing Unit”.

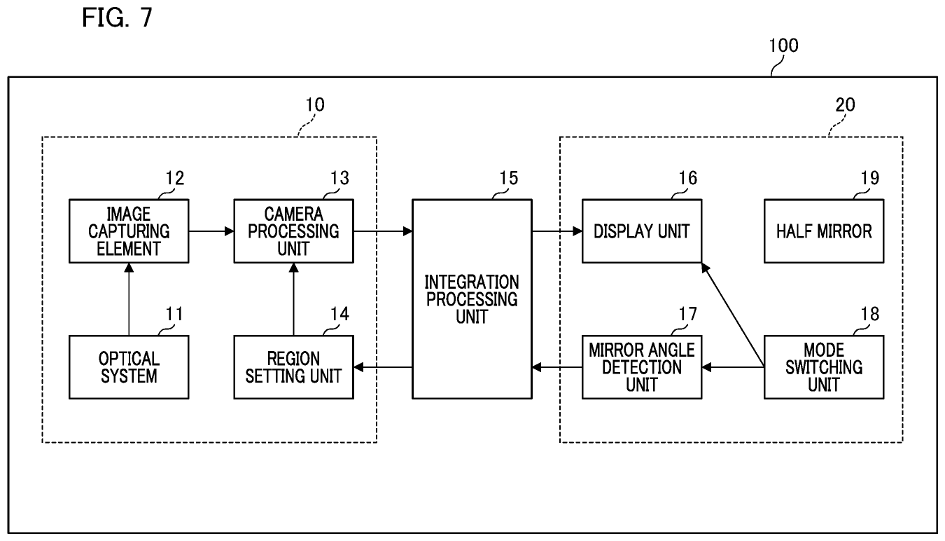

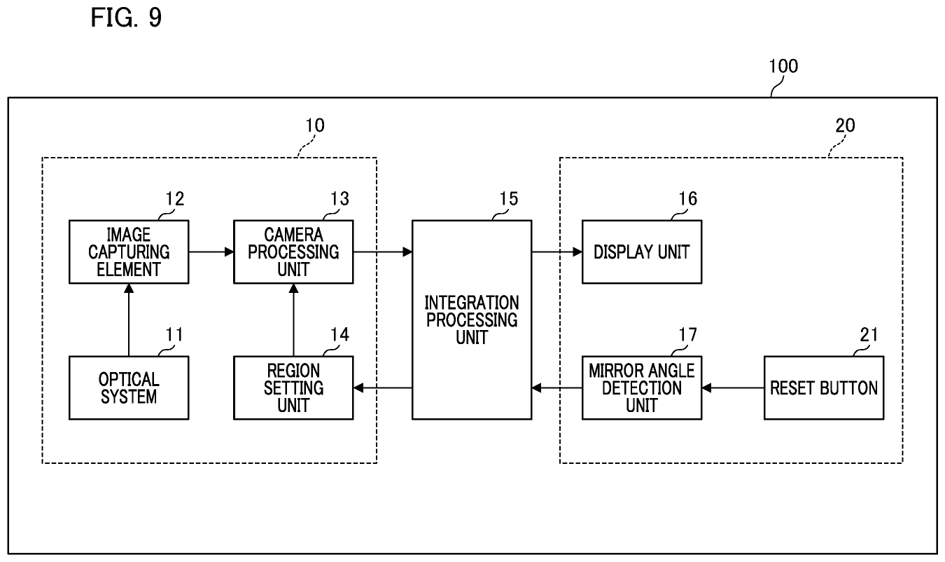

In addition, each of the functional blocks that are shown in FIG. 1 do not need to be encased in the same body, and may also be configured by separate devices that have been connected to each other via a signal path. Note that the above explanation related to FIG. 1 also applies to FIG. 7, and FIG. 9.

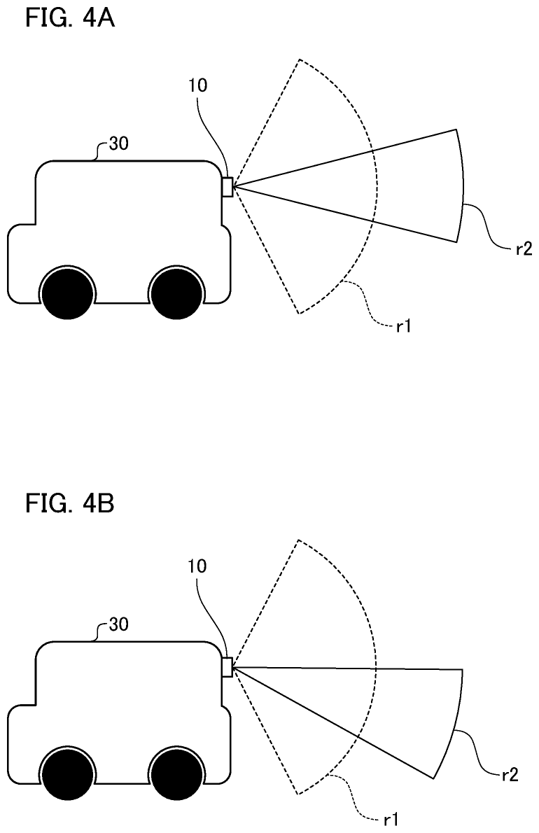

As is shown in FIG. 4, the image capturing system 100 is a system that displays video images captured by an image capturing device 10 that has been disposed so as to capture images of the rear direction of a vehicle 30 on a display device inside the vehicle, and the entirety of the image capturing system 100 is mounted on the vehicle 30 that serves as a moving device. In addition, driving devices such as an engine, a motor, and the like, which are not illustrated, for driving and moving the moving device are mounted in the vehicle 30, which serves as the moving device.

The image capturing system 100 has an image capturing device 10, an integration processing unit 15, and an electronic room mirror 20. Note that the electronic room mirror 20 is an article for displaying a rear direction image that has been captured by the image capturing device 10 for use instead of an optical room mirror. The image capturing device 10 is an image capturing device that is disposed on the vehicle 30 in order to monitor the rear direction of the vehicle, and has an optical system 11, an image capturing element 12, a camera processing unit 13, and a region setting unit 14.

The optical system 11 forms images on a light receiving surface of the image capturing element 12 using light that has entered it from the outside using at least one lens. The image capturing element 12 is an image sensor such as a CCD image sensor, a CMOS image sensor, or the like, and converts an optical subject image that has been formed by the optical system 11 into a digital signal, and transmits this to the camera processing unit 13.

The camera processing unit 13 photographically processes the electronic signal that has been transmitted from the image capturing element 12 into a video image (image data), and performs processing such as WDR (Wide Dynamic Range) correction, gamma correction, LUT (Look Up Table) processing, distortion correction, extraction, and the like. The video image that has been processed by the camera processing unit 13 is transferred to the integration processing unit 15.

In addition, the camera processing unit 13 functions as a resolution conversion unit configured to partially perform resolution conversion to make the resolution for the image data for one region (the high-resolution region) of the screen for the image data a higher resolution than the other regions. In addition, the camera processing unit 13 is also able to change the position of the high-resolution region based on a control signal that is received from the region setting unit 14.

The region setting unit 14 is able to indicate and set the coordinates for the region to be displayed in high-resolution from among the captured regions for the camera processing unit 13 based on angle information for the electronic room mirror 20 that is obtained from the integration processing unit 15. That is, the region setting unit 14 sets the high-resolution region in one portion of the screen.

The method for converting the angle information to coordinate information may be, for example, storing the initial (from when the vehicle is started, or the like) input angle and output coordinates, calculating the change amount for the output coordinates based on the change amount for the input angle, and then determining an output value. For example, if the change amount for the input angle in the vertical direction is defined as ΔθV, the change amount for the input angle in the horizontal direction is defined as Δθh, the movement amount in the horizontal direction of the high-resolution region is defined Δy, the movement amount in vertical direction in the high-resolution region is defined as Δx, and Cy, and Cx are defined as constants, it may be set such that Δy=Cy·Δθ v, and Δx=Cx·Δθh.

The constants Cy and Cx may be arbitrarily changed, and it is possible to determine how much to move the high-resolution region when the electronic room mirror 20 is tilted, that is, to change the sensitivity, by changing these constants. Conversely, a table that associates the input angles and the output coordinates may be saved on a memory or the like, and the output value may also be determined based on this. In this manner, in the First Embodiment, it is possible for the region setting unit 14 to change the movement amount for the high-resolution region in relation to the rotation amount of the display device 16.

In order for the camera processing unit 13 to output partially high-resolution images, for example, a method can be considered in which processing such as averaging or the like is used, and the regions other than the region set by the region setting unit 14 are made relatively low-resolution. In addition, high-resolution may also be achieved by using a technology that generates images that exceed the resolution that would normally be possible for the image capturing element 12 to capture images at by using a plurality of frames (super resolution), and performing super resolution on the regions that are set by the region setting unit 14.

Note that in the case in which a pan-tilt mechanism, which is not illustrated, that is able to change the optical axis direction of the optical system 11 is provided, and the angle change for the electronic room mirror 20 is larger than a predetermined angle, it may also be made such that the direction of the image capturing optical axis is changed to the direction of the region that is set by the region setting unit 14. In this case, it is possible to change the image capturing optical axis according to the output from the region setting unit, and to display a wider range in high-resolution by combining the operations of the high-resolution processing for a portion of the screen.

Generally, when a signal is transferred to the integration processing unit 15 from the camera processing unit 13, it is necessary to transmit this over a distance of a few dozen centimeters to a few dozen meters, and there are cases in which it is difficult to transmit video images in which the signal quality has been maintained at a high bit rate. However, using as technique that partially changes the resolution as has been described above, it is possible to make only the minimum number of regions necessary high-resolution, and to keep the bit rate for the signal low, and it is also possible to stay within the transmission bandwidth.

The integration processing unit 15 has an SOC (System On Chip)/FPGA (Field Programmable Gate Array), a CPU serving as a computer, and a memory serving as a storage medium. Each type of control for the entirety of the image capturing system 100 is performed by the CPU executing a computer program that has been stored in the memory.

In addition, the integration processing unit 15 transmits a video image signal that was received from the camera processing unit 13 to the display device 16. When this happens, the integration processing unit 15 extracts the image including the high-resolution region image from the image data in the camera processing unit 13 based on the information from a mirror angle detection unit 17, which is to be described below, and transmits a video image signal in a format that can be displayed by the display device 16. That is, the display device 16 displays a screen for the image data that has been acquired by the image capturing device 10.

The determination method for the region to be extracted is assumed to be, for example, extracting the center of the high-resolution region at an image size that can be displayed by the display device 16. However, the method is not limited thereto, and for example, the extraction coordinates may also be changed according to angle information from the mirror angle detection unit 17, which is to be described below.

In addition, the integration processing unit 15 transfers the angle information from the mirror angle detection unit 17, which is to be described below. to the region setting unit 14 based on the angle information for the display device 16 of the electronic room mirror 20 The determination method for the output value in relation to the input value is assumed to be, for example, making the output value a linear function of the input value, or the like.

That is, when the input value is defined as θ, and the output value is defined as θ′, it may be made such that θ′=a·θ+b, using the coefficients a, and b. It is possible to change the sensitivity by adjusting the coefficient a, and the reference value for the angle by adjusting the coefficient b. The above-described calculations are performed for the angle information for both the horizontal direction and the vertical direction.

In addition, a non-linear function may also be used that keeps the output values within a set range in relation to the input values that exceed a set threshold so that the image capturing device 10 does not set a high-resolution region that exceeds the range in which images can be captured in the high-resolution region.

In addition, in the case in which an input that exceeds a predetermined threshold has been generated, such as a case in which the angle detection device has detected an angle of inclination that exceeds a predetermined threshold, or the like, the video image signal may also be output to the display device 16 after having superimposed a mark or text that displays a warning on the video image signal from the camera processing unit 13. In addition, a portion or the entirety of the functions of the camera processing unit 13 and the region setting unit 14 may be held inside of the integration processing unit 15.

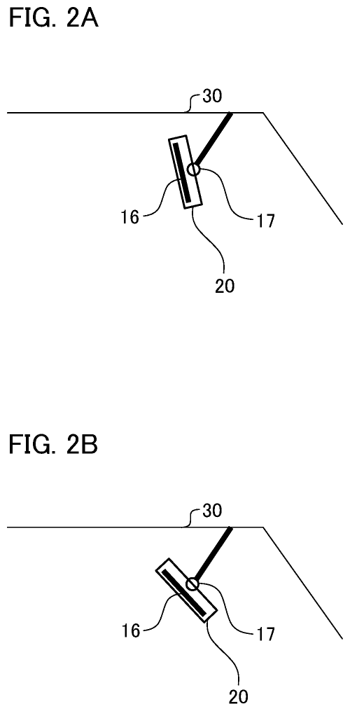

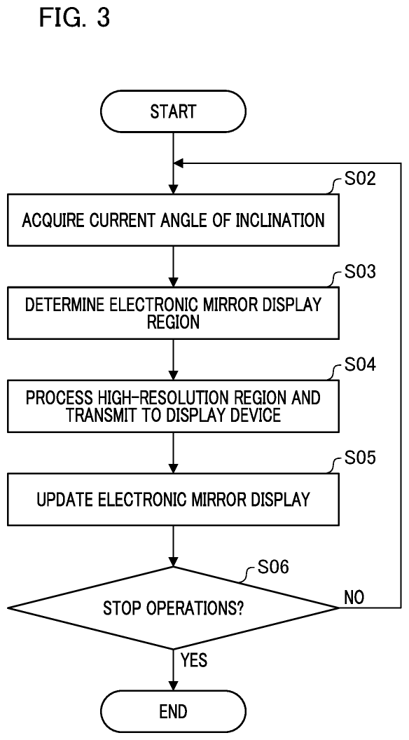

FIGS. 2A and 2B are schematic diagrams in which the electronic room mirror 20, which has been attached to the vehicle, is seen from the side. As will be described below in FIG. 3, the electronic room mirror 20 is a display device for use in confirming the rear direction of a vehicle and is attached inside of the vehicle, and has a display device 16 and a mirror angle detection unit 17.

The electronic room mirror 20 is held to the vehicle 30 by a movable mechanism such as a hinge or the like, and a passenger is able to manually change the orientation of the electronic room mirror 20 within a set range. The display device 16 is a display device such as a liquid crystal panel or the like, and displays a video image of the rear direction of the vehicle that has been received from the integration processing unit 15.

The mirror angle detection unit 17 detects the direction (angle of inclination) in which the display surface of the display device 16 of the electronic room mirror 20 is facing. A method in which for example, an encoder is used, and a value for the hinge angle of the movable mechanism that holds the electronic room mirror 20 is acquired may be used to serve as the detection unit for the orientation of the display surface.

The mirror angle detection unit 17 is able to detect the angle of inclination for at least one of the rotation angle in the vertical direction (the pitch angle), and the rotation angle in the horizontal direction (the yaw angle) as seen by the passenger. The mirror angle detection unit 17 transmits the detected angle information to the integration processing unit 15.

FIG. 3 is a flow chart explaining the operations of the image capturing system 100 in the First Embodiment, and shows an example of a flow for the control of the region that is displayed on the display device 16 when the electronic room mirror 20 has been manually tilted. For example, this flow starts when the power source for the vehicle 30 is turned on, and is sequentially performed by the CPU of the integration processing unit 15 executing a computer program in the memory.

First, in step S02, the mirror angle detection unit 17 acquires the current angle of inclination of the electronic room mirror 20, and transmits this to the integration processing unit 15. In step S03, the integration processing unit 15 calculates angle information based on the current angle of inclination, and transmits the calculated angle information to the region setting unit 14. Then, the region setting unit 14 determines the coordinates of the high-resolution region that should be made the display region for the electronic mirror based on the received angle information, and transmits this to the camera processing unit 13.

In step S04, the camera processing unit 13 performs high-resolution processing on the video image signal from the image capturing element 12 using, for example, interpolation or the like, and transfers this to the integration processing unit so that the region that has been set by the region setting unit 14 becomes the high-resolution region. In addition, in the integration processing unit 15, the high-resolution region is extracted and transmitted as a video image signal in a format that can be displayed by the display device 16.

In step S05, the display device 16 updates the screen, and a video image that corresponds to the actual angle of inclination of the electronic room mirror 20 is displayed on the display device 16. That is, the integration processing unit 15, which serves as a control unit, executes a control step (steps S02 to S05) that changes a position of the high-resolution region that is set by the region setting unit according to the angle of inclination of the display surface that has been obtained by the angle detection unit.

In addition, in the case in which, for example, the electronic room mirror 20 has been rotated in either of the vertical or horizontal directions, the position of the high-resolution region will be moved up and down or left and right in the same direction. That is, the region setting unit 14 moves the position of the high-resolution region in the same direction as the rotation direction of the display surface.

In step S06, whether or not to stop the processing is determined. For example, in the case in which there has been a termination command accompanying the powering off of the vehicle 30, the flow in FIG. 3 will end, and if there is no termination command, the processing will be repeated from step S02.

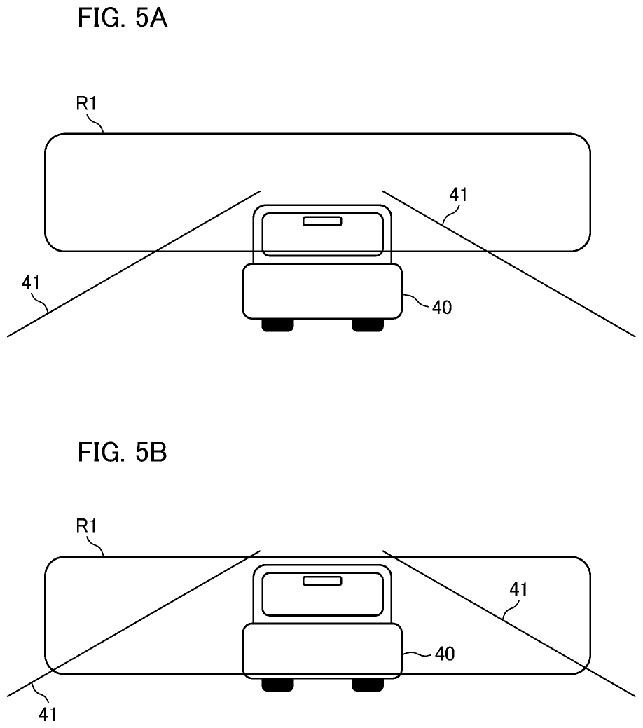

Next, the operations in the Present Embodiment will be explained using FIG. 4, and FIG. 5. It is possible to manually tilt the electronic room mirror 20 from the orientation in FIG. 2A to the orientation in FIG. 2B, for example in the downward direction.

FIGS. 4A and 4B are diagrams for explaining an angle of view of the image capturing device 10 that has been attached to the rear portion of the vehicle 30 in the First Embodiment. In FIGS. 4A and 4B, the angle of view r1 shows the largest angle of view at which the image capturing device 10 is able to capture images, and the angle of view r2 shows the angle of view at which images are captured to serve as the high-resolution region.

Due to the flow that has been explained in FIG. 3, it is possible to change the angle of view in which images are captured to serve as the high-resolution area in the downward direction from the direction that is shown in FIG. 4A to the direction that is shown in FIG. 4B in the case in which the electronic room mirror 20 has been tilted from the orientation in FIG. 2A to a downward orientation such as that in FIG. 2B.

FIGS. 5A and 5B are diagrams for explaining a region of a video image of the rear direction of a vehicle that is displayed on the display device 16 in the First Embodiment. In FIGS. 5A and 5B, the region that has been shown as r1 is the region that is displayed on the display device 16, the reference numeral 40 is a vehicle in the rear direction, and the reference numeral 41 is the borderline of a traffic lane.

It is possible to change the region that is shown on the display device 16 in the downward direction from the region that is shown in FIG. 5A to the region that is shown in FIG. 5B by tilting the electronic room mirror 20 from the orientation in FIG. 2A to the orientation in FIG. 2B.

By the above operations, it is possible to adjust the video image that is shown by the electronic room mirror 20 as if the passenger was moving a conventional optical room mirror. Note that although a case in which the electronic room mirror 20 has been tilted in the downward direction has been explained, the same operations are also performed in cases in which the mirror has been rotated in an upward direction, in a left or right direction, in a clockwise direction, in a counterclockwise direction, or the like.

### Second Embodiment

In the First Embodiment, image data for a region that has been set by the region setting unit 14 is made relatively high-resolution by performing high-resolution conversion. In the Second Embodiment, the angle of view in which images are formed is made smaller per one pixel of the image capturing element 12 for the optical properties in the vicinity of the center of the optical axis of the optical system 11 than for the peripheral regions. Therefore, the telephoto like optical properties are obtained, the vicinity of the center of the optical axis is made high-resolution, and it is made such that wide angle images of the peripheral portions are able to be captured at a low-resolution.

In addition, it is made such that even in a case in which an image of a peripheral region of an image from the image capturing element is displayed by changing the relative positions of the above-described optical system 11 and the image capturing element 12 using a shift mechanism, which is not illustrated, an image of the high-resolution region will be displayed.

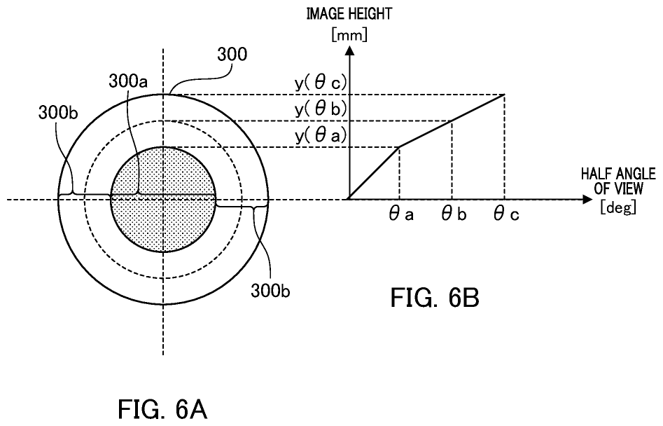

The optical properties of the optical system 11 in the Second Embodiment will be specifically explained using FIG. 6. The optical system 11 is provided with optical properties having an image circle that is able to obtain a high-definition image in the narrow angle of view of the optical axis periphery from among the image capturing angles of view, and forms a subject image on a light receiving surface of the image capturing element 12.

FIGS. 6A and 6B are diagrams for explaining the optical properties of the optical system 11 in a Second Embodiment. FIG. 6A is a diagram showing an image forming height (image height) y at each half angle of view on the light receiving surface of the image capturing element 12 of the optical system 11 in the Second Embodiment as a contour line.

FIG. 6B is a diagram showing projection properties that show the relationship between the image height y and the half angle of view θ of the optical system 11 in the Second Embodiment. In FIG. 6B, the half angle of view (the angle created by the optical axis and the incident light beam) θ is made the horizontal axis, and the image height y on the light receiving surface of the image capturing element (image plane) is shown as the vertical axis.

The optical system 11 in the Second Embodiment is configured such that the projection properties y(θ) of a region that is less than a predetermined half angle of view θa and of a region that is equal to or greater than the half angle of view θa are different, as is shown FIG. 6B.

Therefore, the resolutions differ depending on the region when the increase amount for the image height y with respect to the half angle of view θ per unit is defined as the resolution. It can also be said that the local resolution is represented by a differential value dy(θ)/dθ at the half angle of view θ of the projection property y(θ).

That is, it can also be said that the larger the inclination of the projection property y(θ) in FIG. 6B is, the higher the resolution will be. In addition, it can also be said that the larger the interval for the image height y at each half angle of view as a contour line in FIG. 6A is, the higher the resolution will be.

In the Second Embodiment, the reference numeral 300 in FIG. 6A, which is the image forming surface formed on the image capturing element 12 surface through the optical system 11, is referred to as an image circle, and is assumed to be a property that forms an upright image. Note that a region near the center that is formed on the light receiving surface of the image capturing element when the half angle of view θ is less than the predetermined half angle of view θa is referred to as a high-resolution region 300a, and a region near the outside where the half angle of view θ is equal to or greater than the predetermined half angle of view θa is referred to as a low-resolution region 300b.

In addition, in the Second Embodiment, the circle for the boundary of the high-resolution region 300a and the low-resolution region 300b is referred to as a resolution boundary. In this manner, the optical system in the Second Embodiment is able to form an optical image having a high-resolution region and a low-resolution region on the light receiving surface of the image capturing element.

Note that the optical system 11 in the Second Embodiment is configured such that the projection property y(θ) in the high-resolution region 300a is greater than f×θ (f is a focal distance of the optical system).

In addition, when θmax is defined as the maximum half angle of view of the optical system 11, it is desirable that a ratio θa/θmax between θa and θmax be equal to or greater than a predetermined lower limit value, and for example, it is desirable that the predetermined lower limit value be 0.15 to 0.16.

In addition, it is desirable that the ratio θa/θmax between θa and θmax be equal to or less than a predetermined upper limit value, which, for example, is made 0.25 to 0.35. For example, in the case in which θa is set to 90°, the predetermined lower limit value is set to 0.15, and the predetermined upper limit value is set to 0.35, it is desirable to determine θa within a range of 13.5 to 31.5°.

Moreover, the optical system 11 is configured such that the projection property y(θ) thereof also satisfies the following expression:

$$1 < \frac{f \times sin {θ}_{max}}{y ( {θ}_{max} )} \leq A$$

In this context, f is a focal distance of the optical system 11 as described above, and A is a predetermined constant. It is possible to obtain a higher center resolution than that of a fisheye lens based on an orthographic projection scheme (y=f×sin θ) having the same maximum image formation height by setting the lower limit value to 1, and it is possible to maintain satisfactory optical performance while obtaining an angle of view equivalent to that of the fisheye lens by setting the upper limit value to A.

It is only necessary to determine the predetermined constant A considering the balance between resolutions in the high-resolution region and the low-resolution region, and it is desirable that the predetermined constant A be 1.4 to 1.9.

It is possible to obtain a high-resolution in the high-resolution region 300a and, in contrast, to reduce the amount of increase in image height y with respect to the half angle of view θ per unit, and to capture images with a wider angle of view in the low-resolution region 300b by configuring the optical system 11 as was described above. Therefore, it is possible to obtain a high-resolution in the high-resolution region 300a while setting a wide angle of view that is equivalent to that of a fisheye lens as the image capturing range.

In addition, in the Second Embodiment, properties that are close to those of a center projection method, wherein y=f×tan θ, or an equidistant projection method, wherein y=f×0, that are projection properties of an optical system for use in normal image capturing are set in the high-resolution region (low-distortion region). Therefore, it is possible to decrease optical distortion, and to perform the display in high definition.

Therefore, it is possible to obtain a natural perspective when the surroundings are visually recognized, and to obtain satisfactory visibility while suppressing the degradation of the image quality. Note that because it is possible to obtain similar effects by any projection property y(θ) that satisfies the aforementioned condition of Expression 1, the Second Embodiment is not limited to the projection properties illustrated in FIG. 6B.

Note that although an optical system having the same properties in a concentric direction based on the center of the image circle, which is the optical axis, has been explained, the center of the image circle may also not line up with the optical axis.

In the Second Embodiment, the region setting unit 14 in FIG. 1 changes the relative positions of the center of the image circle (the optical axis of the optical system) and the center of the image capturing element in the case in which a command to change the region has been issued by the integration processing unit 15.

For example, in the First Embodiment, it is possible to change the region that is displayed on the device 16 in the downward direction from the region that is shown in FIG. 5A to the region that is shown in FIG. 5B by tilting the electronic room mirror 20 from the orientation in FIG. 2A to the orientation in FIG. 2B.

However in this case, it becomes such that the image for the low-resolution region that is lower down than the high-resolution region 300 in FIG. 6 is displayed, and this image is made high-resolution.

In the Second Embodiment, when the above happens, in the case in which an upright image is formed on the light receiving surface of the image capturing element, it is possible to move the high-resolution region in the downward direction of the light receiving surface by moving the center of the light receiving surface in the upward direction from the center of the image circle. Therefore, it is possible to display image data for the high-resolution region even in the display state in FIG. 5B.

Note that the relative position change of the image capturing element in relation to the image circle can be realized by, for example, horizontally moving the image capturing element by using a physical movement mechanism such as a rack and pinion gear or the like. Also note that furthermore, in the Second Embodiment, resolution conversion for making a portion of the image data high-resolution such as in the First Embodiment may also be performed.

### Third Embodiment

In the above Embodiment, cases in which the electronic room mirror 20 is an electronic video image display device such as a liquid crystal panel or the like have been described. In contrast, in the Third Embodiment, the electronic room mirror 20 has both the functions of a conventional optical room mirror, and the functions of an electronic video image display device, and the passenger is able to select the mode in which the display will be performed.

That is, in the Third Embodiment, the display device can select an optical mirror mode and an electronic mirror mode, and in the case in which the electronic mirror mode has been selected, the display region is controlled, and the position of the high-resolution region is changed.

FIG. 7 is a functional block diagram explaining the image capturing system 100 in a Third Embodiment, and in FIG. 7, the reference numerals that are the same as those in FIG. 3 show the same functional blocks, and therefore explanations thereof will be omitted.

A mode switching unit 18 is, for example, a switch that has been attached to the electronic room mirror 20, and is an interface for the passenger to switch the settings between either of an electronic room mirror mode (electronic mirror mode) or an optical room mirror mode (optical mirror mode).

In the case in which the optical room mirror mode has been set in the mode switching unit 18, the mode switching unit 18 outputs a command to turn off the display of the display device 16. Conversely, in the case in which the electronic room mirror mode has been set, a command to turn on the display is output to the display device 16. Note that this command may also be carried out via the integration processing unit 15.

In addition, in the case in which the optical room mirror mode has been set in the mode switching unit 18, the mode switching unit 18 notifies the integration processing unit 15 via the mirror angle detection unit 17 that the display mode has become the optical room mirror mode. In addition, the angle detection process in the mirror angle detection unit 17 is stopped.

In contrast, in the case in which the electronic room mirror mode has been set, the mode switching unit 18 notifies the integration processing unit 15 via the mirror angle detection unit 17 that the display mode has become the electronic room mirror mode. In addition, the angle detection process begins in the mirror angle detection unit 17. Note that the integration processing unit 15 may also be notified directly, without going through the mirror angle detection unit 17.

A half mirror 19 is disposed on the front surface of the display device 16, and is able to partially transmit or reflect light. In the case in which the display device 16 is turned off, it operates as the optical room mirror mode using the light that is reflected off of the half mirror 19.

That is, the operator is able to view an optical image of the rear direction via the half mirror. In contrast, in the case in which the display device 16 is turned on, the light that is transmitted from the display device 16 becomes more dominant than the light that is reflected off of it, and it operates as the electronic room mirror mode. That is, the operator is able to view an electronic image that is displayed on the display device 16 via the half mirror.

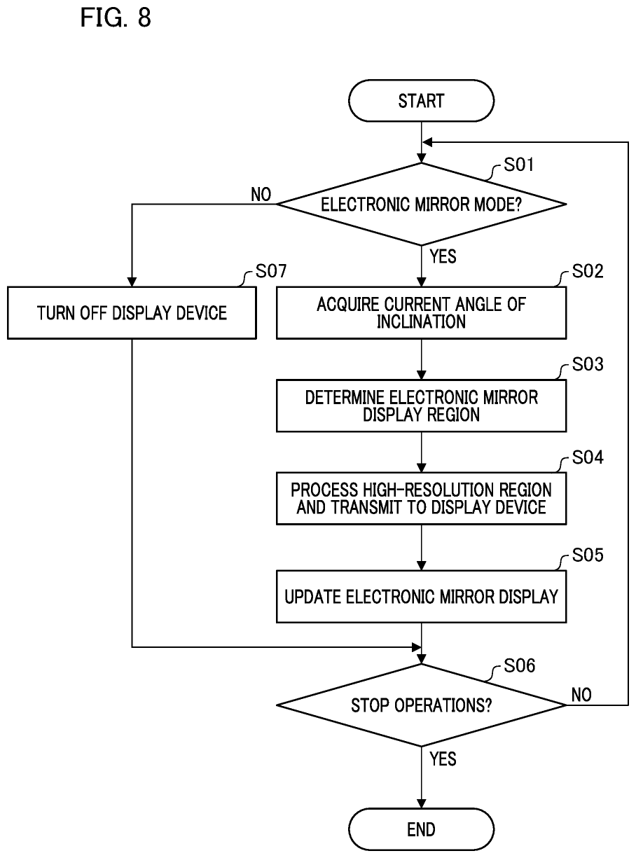

FIG. 8 is a flowchart for explaining the operations of an integration processing unit in the Third Embodiment. The operations of this flow start when the power source for the vehicle 30 is turned on or when the display mode is switched, and in the same manner as in the First Embodiment, are sequentially performed by the CPU of the integration processing unit 15 executing a computer program in the memory.

First, in step S01, the current display mode is determined in the mode switching unit 18. In the case in which the current display is the optical room mirror mode, the processing proceeds to step S07, the mode switching unit 90 turns off the display device 16, and the processing proceeds to step S06.

In the case in which the current display mode is the electronic display mode, the processing proceeds to step S02, and the processing from step S02 to step S05 follows the same flow as in the First Embodiment.

In step S6, whether or not to stop the process is determined, and in the case of No, the processing returns to step S01, and in the case of Yes, the flow in FIG. 7 is finished. Due to the above operations, it is possible to execute control of the display region only in the case of the electronic room mirror mode.

### Fourth Embodiment

In the above-described Embodiments, when the passenger looks at the electronic room mirror 20 from an angle, it is possible that the visibility will be particularly degraded due to the viewing angle of the display device 16. In contrast, if the passenger attempts to adjust the electronic room mirror 20 to an easy to see angle in order to maintain visibility, it is thought that they may unintentionally change the display region.

Taking such a situation into consideration, the Fourth Embodiment is configured such that the display region can be returned to the original settings regardless of what kind of angle the orientation of the electronic room mirror 20 is.

FIG. 9 is a functional block diagram explaining the image capturing system 100 in the Fourth Embodiment, and the reference numerals that are the same as those in FIG. 3 show the same functional blocks, and therefore, explanations thereof will be omitted.

A reset button 21 is, for example, a switch that has been attached to the electronic room mirror 20, and is an interface that the passenger presses to return the display region (the high-resolution region) to the original settings. That is, the reset button 21 functions as a rest unit for resetting the high-resolution region to a predetermined region.

To serve as the operations for when the reset button 21 has been pressed, first a notification that the reset button 21 has been pressed is sent to the mirror angle detection unit 17. The mirror angle detection unit 17, which has received this notification, initializes the angle information in the current orientation of the electronic room mirror 20. That is, each of the current angle values are redefined as, for example, 0°, and the angle information is transmitted to the integration processing unit 15.

Alternatively, the integration processing unit 15 may be notified that the reset button 21 has been pressed, and the same initialization processing may be performed by the integration processing unit 15. More specifically, in θ′=a·θ+b, which is the input-output relation equation for the angle information that was explained in the First Embodiment, the coefficient b is changed, and it is made such that the output value θ′ becomes 0.

### Fifth Embodiment

At least one of the various functions, processes, or methods that have been explained in the above-described Embodiments are able to be realized by using a program. Below, in the Fifth Embodiment, the program for realizing at least one of the various functions, processes, or methods that have been explained in the above-described embodiments will be referred to as “program X”.

Furthermore, in the Fifth Embodiment, the computer for executing the program X will be referred to as the “computer Y”. A personal computer, a microcomputer, a CPU, or the like, are examples of the computer Y. Computers such as the integration processing unit 15 and the like in the above-described Embodiments are also examples of the computer Y.

It is possible to realize at least one of the various functions, processes, or methods that have been explained in the above-described Embodiments by the computer Y executing the program X. In this case, the program X is provided to the computer Y via a computer-readable storage medium.

The computer readable storage medium in the Fifth Embodiment includes at least one of a hard disk device, a magnetic storage device, an optical storage device, a magneto-optical storage device, a memory card, a ROM, a RAM or the like. Furthermore, the computer-readable storage medium in the Fifth Embodiment is a non-transitory storage medium.

### Sixth Embodiment

The moving device (vehicle) in the above-described Embodiments is not limited to an automobile, and may be any type of device as long as it is a movable device having an electronic mirror, such as a motorbike, a bicycle, an electric cart, or the like.

### Seventh Embodiment

In addition, the above-described Embodiments have been configured such that the high-resolution region is changed according to an angle adjustment of the electronic mirror. However, for example, an optical axis direction changing unit such as a pan-tilt drive mechanism for changing the direction of the optical axis of the image capturing device, or the like may be provided, and the optical axis of the image capturing device may also be changed by the optical axis direction changing unit according to the angle of inclination of the display surface of the electronic mirror.

### Eighth Embodiment

In addition, an example has been explained in which the angle adjustment for the electronic mirror is performed by a user directly applying a force to the electronic mirror. However, for example, a motor for changing the angle of inclination of the display surface of the display device may also be provided. In addition, an operating unit such as a joystick, a cross key, a touch panel, or the like may be provided in the moving device, and it may also be made such that the angle of inclination of the electronic mirror is changed by providing a drive source such as the motor or the like with a control signal from the operating unit.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image capturing system through a network or various storage media. Then, a computer (or a CPU, an MPU, or the like) of the image capturing system may be configured to read and execute the program. In such a case, the program and the storage medium storing the program configure the present invention.

This application claims the benefit of Japanese Patent Application No. 2021-205978 filed on Dec. 20, 2021, which is hereby incorporated by reference herein in its entirety.

What is claimed is:

1. An image capturing system having:
an image capturing device;
a display device that displays a screen for image data that has been acquired by the image capturing device; and
at least one processor or circuit configured to function as:
a region setting unit configured to set a high-resolution region in one portion of the screen;
an angle detection unit configured to detect an angle of inclination of a display surface of the display device; and
a control unit configured to change a position of the high-resolution region that is set by the region setting unit according to the angle of inclination of the display surface that has been obtained by the angle detection unit.

2. The image capturing system according to claim 1, wherein the at least one processor or circuit is further configured to function as: a resolution conversion unit configured to make the image data for the high-resolution region that has been set by the region setting unit high-resolution.

3. The image capturing system according to claim 1, wherein the image capturing device has an image capturing element; and an optical system configured to form an optical image consisting of a high-resolution region and a low-resolution region on a light receiving surface of the image capturing element.

4. The image capturing system according to claim 3, wherein the region setting unit is configured to change the relative positions of the optical axis of the optical system and the center of the light receiving surface.

5. The image capturing system according to claim 3, wherein
when a focal distance of the optical systems is defined as f, a half angle of view is defined as θ, an image height on an image plane is defined as y, and a projection property representing a relationship between the image height y and the half angle of view θ is defined as y(θ),
y(θ) in the high-resolution region is greater than f×θ and is different from the projection property in the low-resolution region.

6. The image capturing system according to claim 3, wherein the high-resolution region is configured to have a projection property that is approximated to a center projection method, wherein y=f×tan θ, or an equidistance projection method, wherein y=y×θ.

7. The image capturing system according to claim 3, wherein when θmax is defined as a maximum half angle of view of the optical system, and A is defined as a predetermined constant, the image processing system is configured to satisfy the following equation:
$$1 < \frac{f \times sin {θ}_{max}}{y ( {θ}_{max} )} \leq A$$

8. The image capturing system according to claim 1, wherein an optical mirror mode or an electronic mirror mode can be selected for the display device, and in the case in which the electronic mirror mode has been selected, the control unit changes the position of the high-resolution area.

9. The image capturing system according to claim 1, wherein the angle detection unit is able to detect the angle of inclination in at least one of rotation in the vertical direction or rotation in the horizontal direction of the display surface.

10. The image capturing system according to claim 9, wherein the region setting unit moves the position of the high-resolution region in the same direction as the rotation direction of the display surface.

11. The image capturing system according to claim 10, wherein the region setting unit is able to change the movement amount for the high-resolution region in relation to the rotation amount of the display device.

12. The image capturing system according to claim 1, wherein the at least one processor or circuit is further configured to function as: a reset unit configured to reset the high-resolution region to a predetermined region.

13. The information processing system according to claim 1, wherein the control unit displays a warning on the display device in a case in which the angle detection unit has detected an angle of inclination that exceeds a predetermined range.

14. The image capturing system according to claim 1, wherein the at least one processor or circuit is configured to function as: an optical axis direction changing unit configured to change the direction of the optical axis of the image capturing device according to the angle of inclination of the display surface that has been obtained by the angle detection unit.

15. The image capturing system according to claim 1, further having a motor for changing the angle of inclination of the display surface of the display device; and an operating unit for providing a control signal to the motor.

16. A moving device having a drive device for driving and moving the moving device, wherein the drive device has:
an image capturing device;
a display device that displays a screen for image data that has been acquired by the image capturing device; and
at least one processor or circuit configured to function as:
a region setting unit configured to set a high-resolution region in one portion of the screen;
an angle detection unit configured to detect an angle of inclination of a display surface of the display device; and
a control unit configured to change a position of the high-resolution region that is set by the region setting unit according to the angle of inclination of the display surface that has been obtained by the angle detection unit; and
wherein the image capturing device is disposed so as to capture images of the rear of the moving device.

17. An image capturing method using an image capturing system having:
an image capturing device;
a display device that displays a screen for image data that has been acquired by the image capturing device; and
at least one processor or circuit configured to function as:
a region setting unit configured to set a high-resolution region in one portion of the screen; and
an angle detection unit configured to detect an angle of inclination of a display surface of the display device; and wherein
the method includes a control step to change a position of the high-resolution region that is set by the region setting unit according to the angle of inclination of the display surface that has been obtained by the angle detection unit.

18. A non-transitory computer-readable storage medium configured to store a computer program to control an image capturing system, wherein the image capturing system has:
an image capturing device;
a display device that displays a screen for image data that has been acquired by the image capturing device; and
at least one processor or circuit configured to function as:
a region setting unit configured to set a high-resolution region in one portion of the screen; and
an angle detection unit configured to detect an angle of inclination of a display surface of the display device; and
wherein the computer program executes a control step to change a position of the high-resolution region that is set by the region setting unit according to the angle of inclination of the display surface that has been obtained by the angle detection unit.
